(19) United States
(12) Patent Application Publication
(10) Pub. No.: US 2009/0228393 A1
(43) Pub. Date: Sep. 10, 2009

(54) Method for the quasi real-time preparation and consecutive execution of a financial transaction

(76) Inventor: Andras Vilmos, Budapest (HU)

Correspondence Address: Olson & Cepuritis, LTD., 20 NORTH WACKER DRIVE, 36TH FLOOR, CHICAGO, IL, 60606, US

(21) Appl. No.: 12/380,945

(22) Filed: Mar. 4, 2009

Related U.S. Application Data
(63) Continuation-in-part of application No. 12/322,602, filed on Feb. 4, 2009.
Application No. 12/322,602 is a continuation-in-part of application No. 10/518,951, filed on Sep. 22, 2005, now abandoned.
Application No. 10/518,951 is a continuation-in-part of application No. 10/432,096, filed on May 20, 2003.

(30) Foreign Application Priority Data
Nov. 20, 2000 (HU) P 0004604
Jun. 17, 2002 (HU) P 0202003

(51) Int. Cl. G06Q 20/00; G06Q 40/00

(52) U.S. Cl. 705/44

(57) ABSTRACT

The present invention relates to a method for the quasi real-time preparation and consecutive execution of a financial transaction between a payor and a payee. The method comprises the steps of:
receiving a transaction order by a payor selected financial service provider from the payor;
identifying the payor's account based on the transaction order;
performing a comparison check of the transaction order and the payor's account, wherein when the comparison check is successful executing a balance transformation on the payor's account in accordance with the transaction order;
establishing a communication channel with a payee-selected entity;
notifying the payee-selected entity of the result of the balance transformation over the communication channel, and
completing the financial settlement of the financial transaction.

### CROSS-REFERENCE TO RELATED APPLICATION

This application is a continuation-in-part of co-pending U.S. Ser. No. 12/322,602, filed on Feb. 4, 2009, U.S. Ser. No. 10/518,951, filed on Sep. 22, 2005, and U.S. Ser. No. 10/432,096, filed on May 20, 2003, all being incorporated herein by reference in their entireties.

### FIELD OF THE INVENTION

This invention relates to a transaction method for the preparation and execution of a financial transaction between a payee and a payor.

### BACKGROUND OF THE INVENTION

Today, with the rapid development of computing and mobile telecommunications, cash-free financial transactions linked to purchases are becoming increasingly widespread and often are realized using some sort of data network. These include account settlement with the assistance of the so-called “POS terminal”, as well as the financial offsetting of purchases made on the Internet. Among others, such solutions can be seen in Hungarian Patent No. HU 218.646, and in International publication No. WO 00/23928.

International publication No. WO 95/12859 relates to the settlement of accounts, the essence of which is that the payee, who issues the invoice, issues the invoice on the basis of data received from the payor and then sends it to the payor's bank, which settles the invoice amount by bank transfer. In general this solution may be used for the continuous settling of public utility invoices.

The disadvantage of this approach, however, is that the settlement of the invoice takes place essentially automatically, so the payor, before the transfer, has no way of checking the correctness of the invoice or of the amount. There is no opportunity to refuse the settlement of the invoice, as the payor only knows about the payment after it has taken place.

A further disadvantage is that the issuer of the invoice has access to the payor's data, which may lead to future abuses.

U.S. Pat. No. 6,014,636 relates to the realization of a purchase during which it is not necessary for the payor to be present at the scene of the purchase, instead the payor is able to order the goods or service through a telecommunication network, in an interactive way. The disadvantage of the procedure, however, is that the payor is obliged to settle the value of the goods essentially in advance by bank transfer so that the payor has no guarantee that he/she will actually gain possession of the ordered product or service.

Another disadvantage is that such financial transactions taking place by bank transfer have been known to cause numerous problems. In many cases those gaining unauthorized access to the identification data of the payor withdrew smaller or larger sums from the bank accounts of the customers by carrying out unauthorized transfers, thereby causing losses for them.

HU P 98 02109 discloses a procedure, which attempts to overcome such abuses. The essence of it is that before the performance of a transfer order to a bank account, the account-holding bank sends a request relating to the authorization of the financial settlement of the transaction via a telecommunication network to the party who has authority over the account, who—also using a telecommunication device—sends a confirmation message back. The bank, then, depending on the content of the authorization message received e.g. in an SMS, carries out or rejects the request for the execution of the financial settlement (bank transfer).

The deficiency of this solution, however, is that although it places the payor in a situation where he/she may confirm the transfer, however, neither the payor nor the payee are assured that at the end of the financial transaction the payor will get the product ordered and the payee the money.

U.S. Pat. No. 6,029,150 (Kravitz) discloses a method wherein the transaction order is created and sent to the payor's agent by the payor himself, and the payment advice issued by the agent is sent to the payor who in turn forwards it to the payee. The provisions of this solution effectively eliminates the risk of misuse of the payor's confidential data, however the burden of communication and information transmittal lies with the payor, meaning that the payor needs to be connected to both the agent and the payee throughout the process. Furthermore the payee is required to rely on the payor for forwarding a correct payment advice instead of being provided the possibility of designating a financial service provider of his choice for carrying out this task.

U.S. Pat. No. 6,085,168 (Mori) discloses a similar method wherein a transaction order is created and sent to a buyer's financial institution by the buyer himself. Upon receipt of the transaction order the buyer's financial institution freezes the purchase amount in the balance of the buyer's account and issues a “provisional settlement money”, which is a promissory note like notification confirming that the requested amount has been reserved (frozen in the balance of the buyer's account). Similarly to the payment advice in the above-discussed Kravitz-method, this “provisional settlement money” is transmitted to the buyer, who in turn forwards the “provisional settlement money” to the seller. Thus, as regards the provisional settlement (i.e. the issuance of a promissory note like guarantee prior to the physical settlement of the financial transaction) Mori discloses a similar procedure as Kravitz: the buyer sends a provisional settlement money request (corresponding to the payment request in the Kravitz method) to his own financial institution, which issues the provisional settlement money (corresponding to the payment advice in Kravitz), and transmits it back to the buyer, who in turn sends it to the seller. Hence the Mori-method has the same disadvantages as the previously discussed Kravitz-method, i.e. the buyer must provide for all the communication between the parties; and the seller is forced to accept provisional settlement money issued by a financial institute unknown to him, and forwarded to him by a buyer unknown to him.

The above problems are overcome by a solution which relies on a trusted third party center. The various payees and the payors who intend to purchase the payees' products having to sign in at the same third party center, with the third party center recording both parties' data. This center takes part in all sales transactions by using its own database to check and certify the data of the parties participating in the financial transaction. It handles their accounts, makes it possible to use various cash-friendly methods, and it checks, maintains and updates the client database. Such a solution relating exclusively to the field of e-commerce is described in the abstract of a lecture by PAYS et al. titled “An Intermediation and Payment System Technology” (Computer Networks and ISDN System; North Holland Publishing, Amsterdam, NL; vol. 28. no. 11; 1 May 1996, pages 1197-1206).

The solution described in WO 99/66436 has a similar theoretical basis. It is based on the fact that various clients provide their data to an authorized central representative, who stores their data, and the financial transaction is realized between two registered clients. The representative checks and confirms the data and also carries out the financial settlement of the transaction.

U.S. Pat. No. 5,880,446 (Mori et al.) discloses a similar centralized server system which reduces the number of steps required for carrying out an electronic transaction between a number of participants (payor, payee and financial institution of the payor). Before starting an electronic transaction the payor inputs the necessary information for the transaction to take place, which is then transmitted to the electronic transaction server. The latter retrieves a corresponding electronic transaction procedure from its storage device and distributes a duty procedure to the participants (payor, payee, financial institution of the payor) the names of which are included in the retrieved electronic transaction procedure. The participants can then execute the received duty procedures.

The disadvantage of the foregoing solutions is that both the payee and the payor need to connect to a predetermined central server, thus it is not possible for the parties taking part in the transaction to carry out the transaction via a reliable partner selected by themselves. Accordingly such solutions result in numerous undesired restrictions and extra costs for both parties.

A further disadvantage is that the payor and the payee must both reveal their confidential data, which—because of the compulsory participation—may result in misuse.

Another disadvantage is that the preliminary checking of the financial settlement and the financial transaction cannot be realized in a quasi real-time (often called as real-time) procedure, which in certain cases makes the payor's and the payee's situation difficult, and unreasonably increases the duration of the financial transaction.

The abstract of a lecture by COUSINS et al., titled “InterPay Managing Multiple Payment Mechanisms in Digital Libraries” (Second Annual Conference on the Theory and Practice of Digital Libraries; 11-13 Jun. 1993; pages 1-9; on line accession) relates to a solution similar to the previous ones. In this case again there is a central agent between the payor and the payee, which agent replaces the connection between the payor and the payee and decides on their statements made in connection with the transaction whether the transaction and the payment can be realized or not.

The disadvantage of this solution—similarly to the previous ones—is that the payor and the payee are not in direct contact when taking part in the realization of the transaction, as a result of which the transaction itself becomes slower and quasi real-time checking and quick payment afterwards cannot be realized, which, taking into consideration aspects of security, would be favorable both for the payor and the payee.

Also known is a practically automatic checking and payment system service which makes the simpler realization of transactions possible exclusively in the case of making purchases through the Internet. This possibility is described in the abstract of a lecture by GIFFORD et al., titled “Payment switches for open networks” (Proceedings of the first usenix workshop of electronic commerce; 11-12 Jul. 1995, New York, USA; pages 69-75, 1995 Berkeley, USA, USENIX Assoc.)

The advantage of this solution is that it minimizes the payee's transaction risks and reliably fulfils the requirement that the payor must in fact pay for the purchased product.

However, its significant disadvantage—apart from only supporting purchases made through the Internet—is that in the course of realizing the transaction the payors are significantly restricted and they lose even the possibility of the safe handling of their own personal data, as they must share their data with a party basically unknown to them.

It is an object of the present invention to provide a method for executing a financial transaction between a payor and a payee which overcomes the problems associated with the prior art solution. In particular, it is an object of the present invention to provide a method allowing for the quasi real-time (often referred to as real-time) preparation and consecutive execution of a financial transaction. In the context of the present invention quasi real-time preparation of a financial transaction is understood to comprise financial transactions wherein an electronic payment promissory note is issued by a payor-selected financial service provider quasi real-time, and generally preceding the actual performance of the financial settlement. The promissory note may preferably be forwarded to the payee via a payee selected financial service provider.

It is a further object of the present invention to provide a method which does not require a payor to share confidential data with any other party than a payor-selected financial service provider.

### SUMMARY OF THE INVENTION

A transaction system according to the present invention provides communication between the payor, the payee and their respective financial service providers such as financial institutions in a novel and non-obvious way as compared with the currently known solutions.

In a first aspect of the invention the above objects are achieved by a method for the quasi real-time preparation and consecutive execution of a financial transaction between a payor and a payee. The method comprises the steps of:

receiving a transaction order by a payor selected financial service provider from the payor;

identifying the payor's account based on the transaction order;

performing a comparison check of the transaction order and the payor's account, wherein when the comparison check is successful executing a balance transformation on the payor's account in accordance with the transaction order;

establishing a communication channel with a payee-selected entity;

notifying the payee-selected entity of the result of the balance transformation over the communication channel, and

completing the financial settlement of the financial transaction.

The above method can be performed by a payor-selected financial service provider such as a financial institution (e.g. the payor's bank), this way the payor need only share confidential information relating to his account with his own financial service provider.

Preferably the payee-selected entity is selected from a group consisting of payee, payee's designee and payee-selected financial service provider. The payee preferably selects his own financial service provider such as his own bank or his mobile network operator acting in an account manager capacity, which communicates the information obtained from the payor-selected financial service provider with the payee or any other payee selected third party (designee of the payee).

The payor and the payee may select the same financial service provider, however this is not a requirement and, considering the number of available financial service providers, will only occur as an exceptional case.

In a second aspect of the invention the above objects are achieved by a method for the quasi real-time preparation and consecutive execution of a financial transaction between a payor and a payee which comprises the steps of:

the payee creating unique transaction identifying data for the financial transaction;

the payee providing the payor with the unique transaction identifying data; and

the payor creating the transaction order based on the unique transaction identifying data;

the payor forwarding the transaction order to a payor-selected financial service provider;

the payor-selected financial service provider performing a comparison check of the transaction order and the payor's account, wherein when the comparison check is successful executing a balance transformation on the payor's account in accordance with the transaction order;

the payor-selected financial service provider notifying a payee-selected financial service provider of the result of the balance transformation electronically;

the payor-selected financial service provider and the payee-selected financial service provider completing the financial settlement of the financial transaction.

The transaction method according to the present invention overcomes the disadvantages occurring when executing the cash-free financial transactions. The method ensures that personal and important confidential data of the payee and the payor remain secure, inaccessible to unauthorized parties.

The present invention also allows for quasi real-time checking before actual payment is realized—without the obligatory participation of a third party unknown to both payor and payee and without central identification, checking or authorization—as a result of which the payee is promised by an already known and trusted payee-selected party that the purchase price will definitely be settled, while the payor need only share sensitive personal information with an already known and trusted payor-selected party. In this way checking and informing the payee can be realized practically at the same time, which significantly reduces the actual transaction time.

Further advantageous embodiments of the invention are defined in the attached dependent claims.

### BRIEF DESCRIPTION OF THE DRAWINGS

In the Drawings,

FIG. 1 is a block diagram of a first exemplary embodiment of a transaction system for implementing the method according of the invention.

FIG. 2 is a block diagram of a second exemplary embodiment of a transaction system for implementing the method according of the invention.

FIG. 3 is a flow diagram illustrating the main steps of the method according to the invention.

### DESCRIPTION OF PREFERRED EMBODIMENTS

FIG. 1 shows an exemplary transaction system for implementing the method according to the invention. The transaction system comprises a transaction processing unit 41 of a payor-selected financial service provider 40, and a transaction processing unit 51 of payee-selected financial service provider 50. Units 41 and 51 are connectable via a communication network 60 by establishing an electronic communication channel therebetween. The communication network 60 may comprise devices which preferably belong to the transaction system. For example the communication network 60 may comprise a first data center 61 having communication device 61a via which it may be connected with the transaction processing unit 41 of the payor-selected financial service provider 40. The communication network 60 may also comprise a second data center 62, which is operably connected to the transaction processing unit 51 of the payee-selected financial service provider 50 via communication device 62a. The data centers 61, 62 and their respective communication devices 61a, 62a may be auxiliary devices, with which the transaction processing units 41, 51 may cooperate in a preferred embodiment.

Alternatively, both the transaction processing unit 51 of the payee-selected financial service provider 50 and the transaction processing unit 41 of the payor-selected financial service provider 40 may be operably connected to the communication device 61a of the first data center 61.

The first data center's 61 communication device 61a and the second data center's 62 communication device 62a may optionally be connected to an accounting bank 70 via a data-transmission and operation-performing unit 71. Numerous data centers similar to the data centers 61 and 62 may appear in the communication network 60, all of which can be connected to financial service providers similar to the payor-selected financial service provider 40 and the payee-selected financial service provider 50. For the sake of simplicity, however, only one such payor-selected financial service provider 40 and one such payee-selected financial service provider 50 are shown.

For the invention it is not absolutely necessary to have the accounting bank 70, but it may be desirable from the point of view of carrying out the transactions. It is not necessary either to include data center 61, 62 in the transaction system as the payee-selected financial service provider and the payor-selected financial service provider may be directly linked to each other or may even be the same entity as will be explained later on.

The communication network 60 may be any kind of communication system. A line data-transmission network, a wireless network, or a combination of these can be utilized for this purpose. Their essence is that, irrespective of their construction, the necessary signal groups at the desired speed and reliability level can be transmitted from the transaction processing unit 41 of the payor-selected financial service provider 40 to the transaction processing unit 51 of the payee-selected financial service provider 50, and back. It is to be understood that various devices known in the art may participate when establishing an electronic communication channel between the transaction processing unit 41 of the payor-selected financial service provider 40 and the transaction processing unit 51 of the payee-selected financial service provider 50. The transaction processing units 41 and 51 are typically software applications running on a computer system which comprises hardware devices and further software applications. Thus the electronic communication channel is typically established over an operating system, network card and signal transmitting media. In the context of the present embodiment the electronic communication channel is understood to be an application to application communication channel.

The exemplary transaction system for implementing the inventive method further comprises a payor communication means such as the depicted payor input/output unit 10 belonging to the payor 1 and a payee communication means such as the depicted payee input/output unit 20 belonging to the payee 2. The payor input/output unit 10 is physically in the possession or under control of the payor 1, while the payee input/output unit 20 is in the possession or under control of the payee 2 or optionally a payee selected third party.

The input/output units 10, 20 are typically realized in the form of software application that may be installed on a hardware device such as desk computer, laptop, mobile phone, smart phone, palmtop, notepad, etc. in which case all input, output and processing parts of the input/output units 10, 20 are understood to be software interface and software processing components. However, the input/output units 10, 20 may be understood to comprise hardware units as well. For example, typical hardware units are computer hardware comprising input part-units such as keyboard, mouse; processing part-units such as processor and memory; output part-units such as data outputting and data transmitting components. Similarly the input/output units 10, 20 may be implemented on any other suitable communication means such as mobile phone, smart phone, palmtop, notepad, laptop, etc.

The payor input/output unit 10 and the payee input/output unit 20 are connectable, i.e., temporarily connected, by establishing an electronic communication channel such as the directed data channel 30 depicted in FIG. 1, which is suitable for transmission of information. The directed data channel 30 is understood to be an application to application communication channel, which is realized by various hardware components.

In the interest of data protection, the transaction system may comprise encryption part-units 32. The encryption part-units 32 may be physically positioned in the directed data channel 30, but they may also be a part of the payor input/output unit 10 and the payee input/output unit 20 as well and/or placed in the transaction processing unit 41 of the payor-selected financial service provider 40 as well as in the transaction processing unit 51 of the payee-selected financial service provider 50. The position or relative location of the encryption part-units 32 is unimportant. It is important, however, that by using such encryption part-units 32 the data transmitted over the directed data channel 30 can be protected against unauthorized information acquisition. The directed data channel 30 may also include one or more signal-transmission devices 31a, e.g., radiotelephone, mobile data transmission device, and the like, which make implementation of the communication easier.

In the embodiment illustrated in FIG. 1 the payor input/output unit 10 comprises an own-data input part-unit 11, a payee-data receiving part-unit 12, and a data unification part-unit 13 having a first input 13a connected to the own-data input part-unit 11, and a second input 13b connected to the payee-data receiving part-unit 12. The own-data input part-unit 11 and the payee-data receiving part-unit 12 may be software interfaces or they may be hardware interfaces e.g. the own-data input part-unit 11 may be a human interface (such as keyboard, mouse, touch-screen, etc.) or a portable media interface (such as a portable media reader, a secure card reader, a serial, parallel or USB port for receiving data from other electronic devices, etc.), and the payee-data receiving part-unit 12 may be a network card receiving data transmitted over the directed data channel 30, but may also be a human interface like those in case of the own-data input part unit 11.

The own-data input part-unit 11 preferably comprises an own-data register 11a for storing payor account identification data 1a inputted via the own-data input part-unit 11.

The data unification part-unit 13 further comprises an output 13c which is connectable with the transaction processing unit 41 of the payor-selected financial service provider 40 by establishing an electronic communication channel such as the application to application data-transmission channel 14 depicted in FIG. 1. The data-transmission channel 14—similarly to the previously described electronic communication channels—can be realized over practically any kind of communication system (e.g. transmission line or over a wireless system). The data-transmission channel 14 is suitable for carrying out bi-directional data traffic, and preferably includes an encryption part-unit 14a and may include wireless signal-transmission device 31b.

The task of the encryption part-unit 14a is to protect the information between the payor input/output unit 10 and the payor-selected financial service provider 40 from unauthorized parties. In other words, to create and maintain secure data traffic.

The payor input/output unit 10 may preferably comprise an information-receiving part-unit 15 connectable to the data-transmission channel 14 and serving to handle data transmitted from the payor-selected financial service provider 40.

The own-data input part-unit 11 of the payor input/output unit 10, payee-data receiving part-unit 12, data-unification part-unit 13, and information-receiving part-unit 15 can be integrated into a single device, it can even be formed as a mini computer, which greatly simplifies the positioning and use of the payor input/output unit 10. Alternatively, and as explained before, the payor input/output unit 10 may be various versions of a software application running on a range of devices from PCs, to mobile phones.

The payee input/output unit 20 depicted in FIG. 1 includes an own-data input part-unit 21 that has an own-data register 21a containing payee identification data 2a, inputted via the own-data input part-unit 21. The own-data input part-unit 21 may be similar software, hardware or human interface as explained in connection with the own-data input part-unit 11 of the payor input/output unit 10.

The payee input/output unit 20 further comprises a transaction-data management part-unit 22, which may optionally be equipped with a transaction identifier module 27. The transaction-data management part-unit 22 and the transaction identifier module 27 are typically software components, however the latter may comprise both software and hardware interface for receiving transaction data 2b.

The payee input/output unit 20 further comprises the data-unification part-unit 23, having a first input 23a connected to the own-data input part-unit 21, and a second input 23b connected to the transaction-data management part-unit 22. The data-unification part-unit 23 has an output which is connectable with the payee-data receiving part-unit 12 of the payor input/output unit 10 via the established directed data channel 30. Preferably a payee-data sending part-unit 24 may be provided in addition at the output of the data-unification part-unit 23.

Preferably a payee's data-receiving part-unit 25, and a payor-data receiving part-unit 28 is provided, the latter being in connection with the payee-data sending part-unit 24. The payee's data-receiving part-unit 25 is connectable with the transaction processing unit 51 of the payee-selected financial service provider 40 by establishing an electronic communication channel such as the application-to-application data-transmission channel 26 depicted in FIG. 1. The data-transmission channel 6—similarly to the previously described electronic communication channels—can be realized over practically any kind of communication system. The data-transmission channel 26 may advantageously include an encryption part-unit 26a and, in a given case, a wireless signal-transmission device 31c. The wireless signal-transmission device 31c creates the opportunity for the payee input/output unit 20 to be constructed in such a way that it may be moved around, or even be portable.

Also, in the interest of easier operation, payee input/output unit 20 may have a wireless signal-transmission member 80, which may be a mobile telephone, and the like. A wireless signal-transmission member 80 may be provided for the payor input/output unit 10 as well, and serves a similar role, thus it may be a mobile telephone, or the like.

The payor input/output unit 10 can be built into the wireless signal-transmission member 80 (e.g. installed as a software application), in which case the wireless signal-transmission member 80 takes the role of the wireless signal-transmission device 31a. In a preferred embodiment the payor input/output unit 10 is installed on the wireless signal-transmission member 80 and appears to the payor 1 as a service provided on a mobile telephone. This way the payor input/output unit 10 is portable and the user can keep it in his vicinity. Similarly, the payee input/output unit 20 and the wireless signal-transmission member 80 can be combined into a single, even mobile device as well.

In another preferred embodiment the payor input/output unit 10 and the payee input/output unit 20 can be individual computers or software applications running on individual computers. This is advantageous if the sale or transaction takes place on the Internet. By implementing the payor input/output unit 10 on a laptop or a notebook the payor input/output unit 10 remains portable.

When carrying out the inventive method on the transaction system according to FIG. 1, the payor 1 inputs the payor account identification data 1a required for carrying out the financial transaction into the own-data register 11a of the own-data input part-unit 11 of the payor input/output unit 10. The whole or some of the required payor account identification data 1a may be inputted only once and stored, or it may be inputted individually before or during each electronic transaction. Similarly, the payee 2 loads the payee identification data 2a into the own-data register 21a of the own-data input part-unit of the payee input/output unit 20. The payee identification data 2a comprises data relating to the payee 2 that is essential for the financial transaction to take place (e.g. information identifying the payee-selected financial service provider 50, information based on which the payee-selected financial service provider 50 can identify the payee 2 or the payee's bank account, and data related to the payee 2 himself to allow the payee-selected financial service provider 50 to identify the payee 2 or his designee).

After the payor input/output unit 10 and the payee input/output unit 20 have been loaded in this manner, when the sale or transaction is intended between the payor 1 and the payee 2, transaction data 2b relating to the transaction (such as the transaction value, name/description of the items to be purchased, transaction identification code for the payee, etc.) are provided by the transaction identifier producing module 27 at the payee input/output unit 20. The transaction identifier producing module 27 may generate such transaction data 2b based on information inputted by the payee 2 or by an external software application and the generated transaction data 2b is sent to the transaction data management part-unit 22. The transaction data 2b are, on the one part, stored in the transaction data management part-unit 22 and, on the other part, sent to the data-unification part-unit 23 via the second input 23b of the data-unification part-unit 23.

The payee identification data 2a stored in the own-data register 21a of the own-data input part-unit 21 also goes to the data-unification part-unit 23 via its first input 23a. From the payee identification data 2a and the transaction data 2b the data-unification part-unit 23 creates a transaction order supplement message comprising at least information for contacting a payee-selected entity. The payee-selected entity is preferably the payee-selected financial service provider 50 (as in the present example) or the payee 2 himself. However, the payee-selected entity may be any third party, for example it could be the entity responsible for shipping the purchased goods. The payee 2 may send the transaction particulars directly to the shipping entity, which will start the shipping process immediately after receipt of a positive transaction report (i.e. a promissory note for the payment as will be explained later on).

If the payee-selected entity is the payee-selected financial service provider 50, then the transaction order supplement message comprises at least information identifying the payee-selected financial service provider 50 and information for allowing the payee-selected financial service provider 50 to identify the payee 2 and its account maintained with the organization (or at least a designee of the payee 2). In a preferred embodiment the transaction order supplement message contains only the account ID of the payee 2, and the transaction processing unit 51 of the payee selected financial service provider 50 is configured to identify the actual account and contact a pre-given payee selected entity (typically the payee 2 himself). The data-unification part-unit 23 sends the transaction order supplement message to the payee-data sending part-unit 24, which then transmits it to the payee-data receiving part-unit 12 of the payor input/output unit 10 over the established directed data channel 30. The transaction order supplement message may be encrypted by the encryption part-units 32 associated with the payee input/output devices 20 and decrypted by the encryption part-units 32 associated with the payor input/output devices 10. The encryption part-unit 32 decodes the message thus providing the transaction information 1b in the payee-data receiving part-unit 12, which contains the parameters characteristic of the sale, e.g., the necessary data for transferring the transaction value (purchase price) to the payee 2. Encryption in this communication stage is however not necessary as the transaction order supplement message does not contain real sensitive information.

The payee-data receiving part-unit 12 of the payor input/output unit 10 sends at least the necessary transaction information 1b to the data-unification part-unit 13 via the second input 13b of the data-unification part-unit 13, and sends at least the payor account identification data 1a necessary for identifying the payor 1 by the transaction processing unit 41 of the payor-selected financial service provider 40, which is stored in the own-data register 11a of the own-data input part-unit 11 via the first input 13a to the data-unification part-unit 13. The data-unification part-unit 13 creates a transaction order from the payor account identification data 1a and the transaction information 1b with the help of which the payor-selected financial service provider 40 is able to identify at least the payor's account 1 and the amount to be transferred, as well as contact information of the payee-selected entity (in the present example the payee-selected financial service provider 50).

When the transaction order has been prepared, the data-unification part-unit 13 encrypts the transaction order with the help of the encryption part-unit and sends it via the data-transmission channel 14 to the transaction processing unit 41 of the payor-selected financial service provider. Here, on the basis of the transaction order, the payor-selected financial service provider 40 performs a comparison check of the transaction order and the payor's account, and in particular whether sufficient funds are available on the payor's account for covering the requested transaction value. If sufficient funds are available the payor-selected financial service provider 40 freezes the amount in the balance whereby a balance transformation is performed and a transaction report is issued as the result of the balance transformation. The transaction processing unit 41 then establishes a communication channel over the communication network 60 (optionally including the first data center 61 and possibly including the second data center 62) with a payee-selected entity. In this case the payee-selected entity is the payee-selected financial service provider 50 which routes the communication to the transaction processing unit 51, or the payee-selected entity is the transaction processing unit 51 itself. In either case the payor transaction processing unit 41 transmits the transaction report to the payee transaction processing unit 51.

If on the other hand the payor's account does not allow for the transaction to be carried out the result of the balance transformation is negative. A transaction report is generated in this case as well, however, the payor may ask that such negative transaction report be transmitted only to him (i.e. back to the payor input/output unit 10), allowing him to chose another bank account with sufficient funds, or allowing him to terminate the purchase procedure.

The transaction report preferably includes information on whether the transaction can be carried out based on the balance of the payor's 1 account held at the payor-selected financial service provider 40. If the transaction report is positive (i.e. the transaction can be carried out) it serves as a promissory note for the payment and the payee-selected entity is informed that the payment (transaction) will be carried out (possibly subject to other conditions, such as the payees confirmation of the intended transaction) before the physical settlement of the financial transaction can take place. This provision allows for the realization of quasi real-time financial transactions as the payee can be informed quasi real-time via the payee-selected entity of the intended payment and, based on the promissory note fore the payment, may provide goods and service in advance without having to wait for the lengthy transaction operation to take place.

If the payee-selected entity is not the payee 2 but rather the financial service provider 50 of the payee, then the payee-selected entity informs payee 2 (or any other secondary payee-selected entity) of the result of the balance transformation made by the payor-selected financial service provider 40. In the present example the transaction processing unit 51 of the payee-selected financial service provider 50 creates a second transaction report based on the transaction report received from the payor-selected financial service provider 40. The second transaction report may be identical with the transaction report received from the payor-selected financial service provider 40, in which case the payee-selected financial service provider need only forward the received transaction report. The transaction processing unit 51 determines the secondary payee-selected entity, which is the payee 2, and establishes a communication channel with the secondary payee-selected entity, and more particularly with the communication means of the secondary payee-selected entity, being the payee input/output device 20 in the present example.

The form of communication channel to be established depends on the payee input/output device 20, e.g. an application to application Internet communication channel may be opened if the payee input/output device 20 is connected to the Internet, or e.g. mobile telecommunication channel may be opened, or an open mobile communication channel opened by the payee input/output device 20 used if the payee input/output device 20 is a mobile phone or a software application running on a mobile phone device. Any other suitable communication channel may be used. In the present embodiment the communication channel is the data-transmission channel 26.

The transaction processing unit 51 then transmits the transaction report to the secondary payee-selected entity (being the payee input/output unit 20 in the present example). The form of the transaction report may depend on the type of communication channel established between the transaction processing unit 51 and the secondary payee-selected entity (the payee input/output unit 20). For example if the communication channel is the Internet the payee 2 may receive an electronic message appearing in the payee input/output unit 20, or if the communication channel is a mobile telecommunication channel the payee 2 may receive an sms containing the transaction report. Furthermore, the payee 2 is not restricted to direct the transaction report to his input/output unit 20, for example his input/output unit 20 used for creating and forwarding the transaction order supplement message may be a computer, while an other type of communication means such as the payee's mobile phone may be given as the secondary payee-selected entity to which the transaction report should be transmitted, e.g. in the form of an sms or a voice message.

In the present example the transaction processing unit 51 of the payee-selected financial service provider 50 sends the transaction report via the established data-transmission channel 26 to the payee input/output unit 20 where it is received by the data-receiving part-unit 25. The transaction report sent to the payee input/output unit 20 may advantageously contain the transaction data 2b sent from the payee 2, thus the content of the message can be checked.

In the case of purchase transactions the actual transaction is preferably carried out after confirmation by the payee. If the data received in the transaction report, especially the transaction data 2b including the transaction ID and the amount intended to be transferred, agrees with the transaction data 2b stored in the payee's 2 payee input/output unit 20, then the payee input/output unit 20 sends a confirmation message encrypted with the help of the encryption part-unit 26a via the data-transmission channel 26 to the payee-selected financial service provider 50, which in turn sends this message back to the payor-selected financial service provider 40. Following this, the payor 1 selected financial service provider 40 can carry out the financial transaction regarding which it sends a transaction confirmation message with the help of the data-transmission channel 14 to the information-receiving part-unit 15 of the payor input/output unit 10.

The transaction report can arrive within a very short time after the transaction order has been sent from the payor input/output unit 10, thus the payee is informed quasi real-time of the intended payment transaction, allowing for quasi real-time purchase to take place. For example the payee 2 may provide on-line services straight after having received the financial service providers' 40, 50 report of the intended payment (i.e. the transaction report).

Optionally, the payor input/output unit 10, apart from sending the transaction order made by the data-unification part-unit 13 to the payor-selected financial service provider 40 as explained above, may also send back at least part of the transaction order to the payor-data receiving part-unit 28 of the payee input/output unit 20 via the directed data channel 30. This way, later on the original message sent to the payor-data receiving part-unit 28 can be compared with the content of the transaction report based on information sent along the route: payor input/output unit 10—data-transmission channel 14—payor-selected financial service provider 40—communication network 60—payee-selected financial service provider 50—data-transmission channel 26—payee's data-receiving part-unit 25.

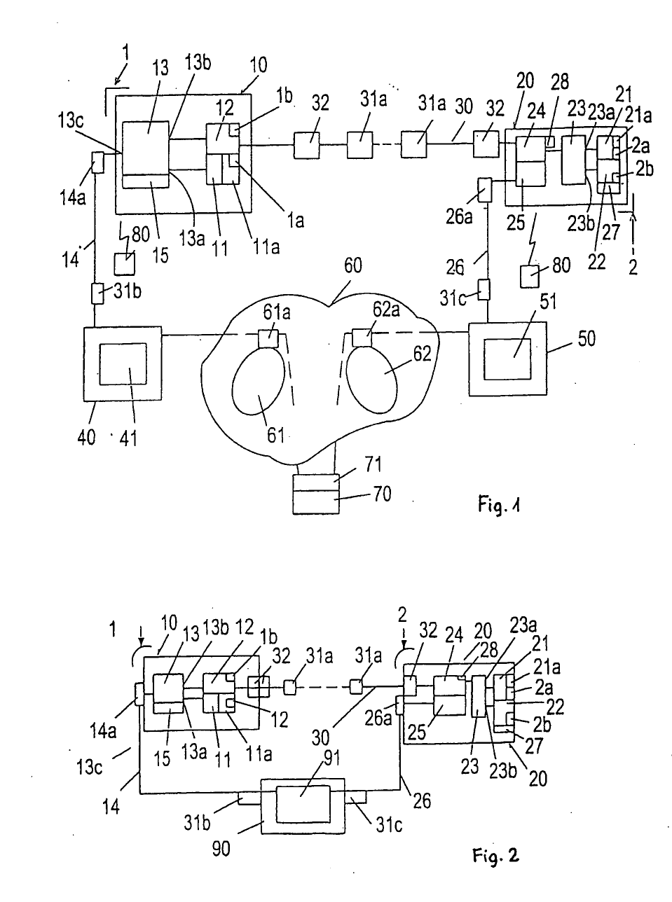

FIG. 2 is similar to the transaction system shown in FIG. 1 except that the payor 1 and the payee 2 have selected same financial service provider 90 for the transaction. A transaction processing 91 unit is provided at the common financial service provider 90 for processing the transaction orders.

The operation of the transaction system according to FIG. 2 is similar to the operation discussed in connection with FIG. 1, with the exception that the payee-selected entity is regarded to be the payee 2.

As explained above the payee 2 may designate any third party as the primary payee-selected entity (e.g. the payee-selected financial service provider 50) to be informed of the result of the balance transformation (i.e. whether the transaction will be carried out) directly by the payor-selected financial service provider 40, but the payee may also designate any third party as a secondary payee-selected entity to be informed by the primary payee-selected entity of the result of the balance transformation.

In the present example the primary payee-selected entity is the payee-selected financial service provider 50 and the secondary payee-selected entity is the payee 2 himself (the payee input/output unit 20). If the transaction processing unit 91 finds that the transaction order contains the payor-selected financial service provider 50 (also denoted with the number 90 in this embodiment) as the primary payee-selected entity, it takes over the role of the transaction processing unit 51 of the payee-selected financial service provider 50, and regards the secondary payee-selected entity to be the payee-selected entity who must be informed of the result of the balance transformation. Thus in this embodiment the payee 2 becomes the payee-selected entity and the transaction report (composed by the transaction processing unit 91 of the common financial service provider 90) is sent to the payee input/output unit 20 directly. As explained above the transaction report could be sent to any third party designated by the payee 2 as the secondary payee-selected entity.

Preferably, the common transaction processing unit 91 operates first as the transaction processing unit of a payor-selected financial service provider, after which it takes over the role of the transaction processing unit of a payee-selected financial institution. This way the applicability of the transaction processing units 41, 51 is not restricted in a way as to require a common financial service provider. Preferably each transaction processing unit 41, 51, 91 may operate both as the transaction processing unit at the payor-selected financial service provider 40 and as the transaction processing unit at the payee-selected financial service provider 50. Hence, if the two financial service providers 40, 50 coincide (referred to as the common financial service provider 90) and consequently the two transaction processing units 41, 51 coincide as well (referred to as the common transaction processing unit 91) the common transaction processing unit 91 takes the role of both the payor-selected financial service provider transaction unit 41 and the payee-selected financial service provider transaction processing unit 51. The common transaction processing unit 91 receives the transaction order, processes it, based on which it generates a transaction report, which it virtually forwards (i.e. without involving a physical communication network) to its own software component adapted to receive a transaction report when operating as the payee-selected transaction processing unit 51. After this, the common transaction processing unit 91—acting as the payee-selected transaction processing unit 51—creates a second transaction report on the basis of the transaction report (or uses the received transaction report as his own). The common transaction processing unit 91 determines the payee-selected entity by identifying the secondary payee-selected entity to be informed by the transaction processing unit 91 in its capacity as the transaction unit of the payee-selected financial service provider, and establishes a communication channel with the determined payee-selected entity (being the payee input/output unit 20 in the present example). As explained above the form of communication channel to be established depends on the secondary payee-selected entity—in the present example data transmission channel 26 is established.

The transaction processing unit 91 then transmits the transaction report to the determined payee-selected entity (being the payee input/output unit 20). In the present example the form of the transaction report is preferably an electronic message appearing in the payee input/output unit 20. The transaction report may be confirmed by the payee 2 as explained in connection with FIG. 1. The confirmation message is received and processed by the transaction processing unit 91 of the common financial service provider 90, after which the transaction may take place (from the payor's account to the payee's account).

For the operation of the transaction system, the encryption part-unit 32, the encryption part-unit 14a and the encryption part-unit 26a are purely optional, and the wireless signal-transmission device 31a, the wireless signal-transmission device 31b and the wireless signal-transmission device 31c are optional but not essential elements. However, their utilization significantly simplifies the use of the transaction system and makes it more secure from the point of view of data protection.

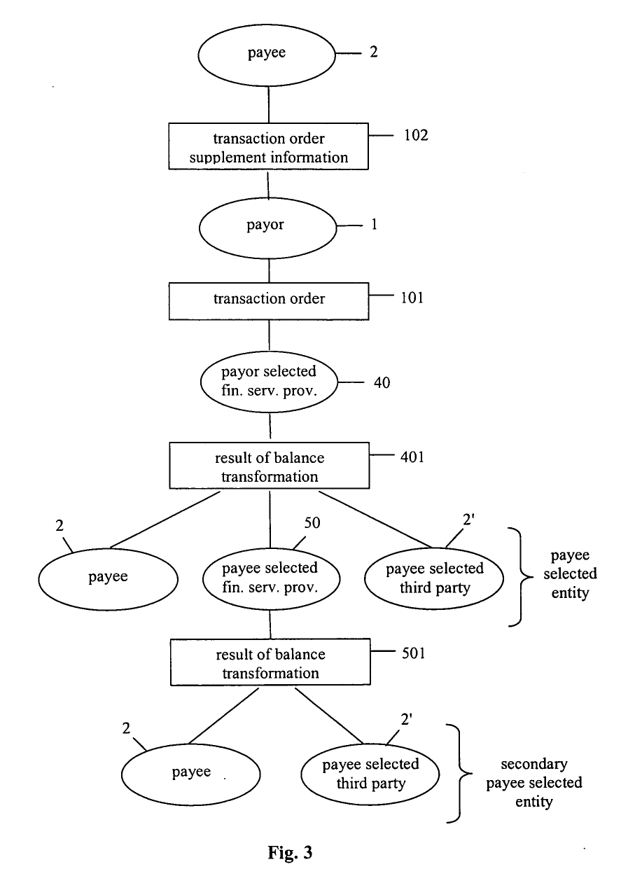

The flow diagram in FIG. 3 depicts the main steps and participants of the method according to the invention. As can be seen the payee 2 provides transaction order supplement information in step 102, which can be for example the transaction order supplement message containing particulars of the transaction and information for contacting a payee-selected entity as explained in connection with the embodiment illustrated in FIG. 1. However the transaction order supplement information may be provided in other suitable form, e.g. communicated over the telephone or in person, or e.g. contained in paper or electronic advertisement. The payor 2 may be in possession of the necessary transaction order supplement information without the payee's 2 active participation, for example in the case of non-business like transaction e.g. financial support between family members, the payor 1 and the payee 2 may have a common bank account or the payor 1 may know the beneficiary's (payee's 2) account number and the payor 1 may transfer money to the common bank account, or the other account known to him and may wish the payee 2 (i.e. the other account holder) to be informed of the transfer prior to the sum actually appearing on the bank account. In this case the payee 2 does not need to provide the payor 2 with any information since all the necessary information is known to the payor 2 already.

The payor 1 gaining knowledge of the information necessary for initiating the transaction gives a transaction order to a payor-selected financial service provider 40 (such as a financial institution, e.g. a bank) in step 101. This may be done by means of an IT device as explained in connection with FIG. 1, however, a transaction order may be given in various others ways, e.g. over the telephone (e.g. using a so-called telephone banking service) or e.g. in person (e.g. in a bank) or e.g. via an agent.

The transaction order is processed at the payor-selected financial service provider 40 whereby, if sufficient funds are available on the payor's account, the payor-selected financial service provider 40 reserves the amount in the balance of the account and the result of the balance transformation is communicated to a payee-selected entity in step 401. The result may be communicated in the form of a transaction report as explained previously. The communication in Step 401 is carried out by establishing a communication channel preferably utilizing a pre-existing communication network, which is understood to comprise telecommunication and IT (electronic) networks as well. For example the payor-selected financial service provider 40 may communicate with the payee-selected entity via telephone, facsimile, GSM network, radio-telephone, Internet, wireless Internet, etc. and any combination thereof or any other technical means allowing for communicating with a distant party quasi real-time. Note that up to step 401 all the required communication could have been carried out without using any technical means, e.g. personal meeting. However, in order to ensure quasi real-time information transmission technical communication means are needed in step 401 for establishing the communication channel. The only exception being the case when the payor selected and payee selected financial service providers are the same entity in which situation however, on the one hand system internal processing needs to be established, and on the other hand a secondary payee selected entity needs to be notified by the common financial service provider in step 501 via technical communication means.

If the payee-selected entity is the payee 2, he is informed quasi real-time of the intended payment. If the payment relates to a business transaction the payee 2 may provide goods or services right after receipt of the transaction report, which serves as a promissory note for the payment. The transaction may relate to a non-business like settlement, e.g. alimony, child support, support between family members, etc., in which case the payee is informed quasi real-time that the transaction has been initiated, providing a higher level of financial security for the payee (e.g. he or she may undertake steps incurring costs in possession of the promissory note like communication issued by the payor-selected financial service provider).

If the payee-selected entity is a payee-selected financial service provider 50 the result of the balance transformation (i.e. the transaction report) will be provided to the payee 2 (or any other payee-selected third party 2′) by his own financial service provider in step 501. Thus the payee need not be in contact with any other party than his own financial service provider (e.g. bank), which he knows and trusts. By giving both the payor 1 and the payee 2 the freedom of choice as regards their financial service provider, the present invention provides a much more flexible system than any of the prior art solutions, where quasi real-time transactions were only possible between parties having opened accounts with a common financial service provider. Furthermore, in light of the real time payment information—promissory note—provided by the payor selected financial service provider 40, the payee selected financial service provider 50 may even advance the actual money to the payee 2, or the payee 2 may receive commercial credit in its purchase transactions. The real time payment notification of the payment transaction even without real time clearing and settlement may substantially accelerate the commercial transactions.

The payee may designate any other payee-selected third party 2′ as well as explained previously. Moreover, the payee may designate a plurality of payee-selected entities as well, in which case the payor-selected financial service provider 40 notifies all the payee-selected entities, or the payor-selected financial service provider 40 attempts to notify the payee-selected entities in the order given in a preference list provided by the payee 2 and stops at the payee-selected entity where the notification is successfully carried out.

Examples will now be presented to give further details on the application of the present invention.

### Example 1

In this example the business transaction takes place over the Internet. The payor 1, using the payor input/output unit 10 (e.g. a computer connected to the Internet), selects the product to be ordered and sends the order to the payee input/output unit 20 of the payee 2 over the communication channel 30. The payee input/output unit 20 generates a transaction order supplement message containing the transaction particulars (such as transaction ID and purchase value), and information for communicating with a payee-selected financial service provider 50 and for allowing the payee-selected financial service provider 50 to identify the payee's account (e.g. the payee's bank account ID, an alias to the account number, is given, identifying both the bank and the payee's account).

The payor 1 checks the transaction related data contained in the transaction order message, and if it corresponds to his Internet order, the payor 1 creates a transaction order based on the transaction order supplement message and comprising his own details as well (such as bank account number) and sends this transaction order to his financial service provider 40 via his input/output unit 10.

It should be noted that optionally a single transaction order may even relate to a plurality of purchases each having a different transaction ID and possibly even having different transaction designations. For example the payor 1 may be in contact with a plurality of merchants (payees 2) and may purchase different items over the Internet from each merchant 2, in which case the payor input/output device 10 may receive all the transaction order supplement messages from all the merchants 2 and unite them in a single transaction order listing all the sub-transaction orders in connection with all the purchases made at the different websites of the different merchants 2.

The transaction processing unit 41 of the payor-selected financial service provider 40 processes the transaction order, thereby checking whether the requested transaction can be carried out. If sufficient funds are available on the payor's account the payor-selected financial service provider 40 reserves the amount in the balance of the payor's account whereby a balance transformation is performed. A transaction report is issued for communicating the result of the balance transformation. The transaction report is transmitted by the transaction processing unit 41 to the payee-selected financial service provider 50 based on the information provided in the transaction order.

Upon receipt of the transaction report the transaction processing unit 51 of the payee-selected financial service provider 50 identifies the payee 2 and determines the payee-selected entity to be informed of the result of the balance transformation. The payee 2 may have provided the details of the secondary payee-selected entity in advance (e.g. when requesting this service from his financial service provider 50), or it may have been contained in the transaction order supplement message and consequently in the transaction order as well, in which case this information is transmitted to the payee-selected financial service provider 50 together with transaction report.

A second transaction report may be generated by the transaction processing unit 51 of the payee-selected financial service provider 50 corresponding to the transaction report received from the transaction processing unit 41 of the payor-selected financial service provider. Optionally the received transaction order may simply be forwarded to the secondary payee-selected entity (being the payee 2 in the present example).

Upon receipt of the transaction report, which preferably contains the transaction ID assigned to the transaction by the payee 2, the payee 2 may be required to check and confirm the transaction. If the data received in the transaction report, especially the purchase value (i.e. the amount intended to be transferred), conforms with the data stored in the payee input/output unit 20 for the given transaction ID, then the payee 2 accepts the transaction by creating a confirmation message via the payee input/output unit 20, and sends the confirmation message back to the payee-selected financial service provider 50. Optionally the whole process of receiving the transaction report, comparing its content with that of the stored transaction data and sending a response to the payee-selected financial service provider 50 may be fully automated in the payee input/output unit 20. Having received the confirmation message the payee-selected financial service provider 50 sends this message (or the contents thereof) back to the payor-selected financial service provider 40. Following this, the payor-selected financial service provider 40 can carry out the settlement of the business transaction and may also send a transaction confirmation message to the payor input/output unit 10.

If the result of the balance transformation is positive, i.e. the payor-selected financial service provider 40 was able to perform the balance transformation, then the transaction report (i.e. the report on the result of the balance transformation) serves as a promissory note for the settlement of the transaction. The payee 2 can be sure that the indicated amount will be transferred to his account, optionally on condition e.g. of a confirmation message by the payee 2. The payee 2 may start shipping or providing goods or service straight away, knowing that the purchase value is on its way to his account, or that the clearing and settlement will take place in the normal settlement cycle of the banks. For example if the purchased goods or services can be provided on-line the above described procedure allows for quasi real-time on-line business transactions to take place as the goods and services can be made available to the payor 1 upon receipt of the promissory note, i.e. within a very short time from having given the transaction order.

If however the result of the balance transformation is negative, i.e. the payor-selected financial service provider 40 was not able to perform the balance transformation (e.g. due to lack of funds) then the payor may choose not to notify the payee-selected entity of the failed transaction. In this case the negative transaction report may be sent to the payor 1 informing him that the transaction was unsuccessful, which allows the payor 1 to correct any errors made in the transaction order or retry with a different account or to choose less expensive goods or services.

### Example 2

In the present example the payee 2 and the payor 1 meet directly, in other words the business transaction does not take place through any information forwarding communication network, but in person. After the business transaction has been concluded the payee 2 issues an invoice to the payor 1 that the payee input/output unit 20 prepares and prints out. The serial number of the invoice may serve as the transaction ID. On the basis of the invoice received in this way the payor 1 prepares a transaction order containing the transaction ID, the purchase value, data relating to his account to be debited and—unless the payee-selected financial service provider 50 has been pre-informed of the secondary payee-selected entity—information relating to the entity to be informed of the result of the balance transformation in advance.

From here on the transaction procedure may be the same as described in Example 1.

### Example 3

In the present example the payor 1 contacts the payee 2 through a telecommunication network (e.g. by telephone) over which the business transaction is concluded. Following this the payee 2 issues an invoice (e.g. a strictly numbered printed document coming from an invoice book). The payee 2 informs the payor 1 of the invoice serial number relating to the transaction (which can serve as the transaction ID), the account where the transfer should be directed to, and a contact number where the payee 2 can be reached at (e.g. over the telephone), based on which the payor 1 may proceed with composing the transaction order. Instead of sending a transaction order via the payor input/output unit 10 the payor may chose to make the payment order via telephone as well, e.g. by calling a personal banker or an automatic transaction service provided over the telephone (telephone banking) where the payor 1 may simply enter the amount to be transferred and the destination account (besides giving his personal identification data as is common in case of such telephone services). The details of the transaction are entered by the personal banker, or recorded during an automatic session into the IT system of the payor's bank 40. The transaction order is routed to the transaction processing unit 41, which processes the transaction order and creates the transaction report, which is then forwarded to a payee-selected entity 2′ over a communication channel allowing for quasi real-time notification. For example the transaction report is transmitted to the payee's bank 50 which in turn informs the payee 2 based on the contact number included in the transaction order and consequently in the transaction report as explained above.

As is clear from the above-going neither the payee 2 nor the payor 1 needed to use any special input/output unit 20, 10, and the key steps of the procedure are performed by the payor financial service provider 40 (receiving the transaction order, processing it, performing a balance transformation on the payor's 1 account and informing a payee selected entity 2′ of the result of the balance transformation in the form of a transaction report over a fast communication channel).

At this point the payee 2 has obtained guarantees that he will receive the price of the product to be supplied by him, but the payor 1 has not yet received the product. Optionally in the present example we may increase the level of performance guarantee for the payor too, by establishing the condition that the financial settlement is only initiated after the payor 1 has received the ordered product and has sent a performance confirmation to his bank 40 that the financial settlement may be initiated. Thus, here, although the promissory note for the transaction of the purchase price is issued quasi real-time and the payee 2 may start supplying the product immediately; however the payment will only be made once the payor 1 receives the product and sends the performance confirmation to his bank 40.

### Example 4

The present example relates to a non-business like transaction, such as financial support for a family member, in which case no goods or services are provided in return, e.g. sending money to a son (or daughter) studying abroad. Normally when such a transaction is initiated the parent must inform the son about the initiated transaction through a different communication channel, such as telephone, otherwise the son will only gain knowledge of the transaction once the amount is entered on his bank account, and cannot calculate with the money in advance. The present invention can be applied to solve this problem. Once the parent (being the payor 1) gives the transaction order to his own bank 40 (e.g. in any of the aforementioned ways) to transfer money from his own account to the son's account held by the son's financial service provider (e.g. a bank or a mobile network operator) the transaction processing unit 41 of the parent's bank 40 processes the transaction order and issues a transaction report to the son (being the payee 2) or to the son's financial service provider 50 where the amount is to be transferred. The son's bank, or mobile network operator acting as a financial service provider 50 managing user accounts will in turn send a transaction report to the son 2, whereby the son 2 is informed quasi real-time of the initiation of the transaction. He may then calculate with the money that he is about to receive within a couple of days. In this case the son 2 does not need to confirm the transaction (although he may), since he is a passive party to the transaction in the sense that he does not need to provide goods or services in exchange. For the present application of the method according to the invention the parent (payor 1) and the son (payee 2) do not need special input/output units 10, 20. The parent 1 may give a transaction order in any conventional way (e.g. e-banking, telephone banking, going to the bank personally) and the son 2 may receive the transaction report via a regular mobile handset (e.g. in the form of a text message). The transaction report may be transmitted to the son 2 directly by the parent's bank 40 or with the intermediation of the son's financial service provider 50 (e.g. a bank or a virtual or real mobile network operator acting in an account manager capacity). In this case a transaction identifier might be provided by the parent 1, e.g. in the form of a comment to the transaction, which then may be included in the transaction report and transmitted to the son 2. Alternatively a transaction identifier may also be allocated to the transaction by the parent's bank 40. The account number and/or the name of the account holder (the parent 1) may also be transmitted together with the transaction report in order to inform the payee 2 (son) of the origin of the payment.

As can be seen all the key steps of the inventive method are performed by the payor financial service provider 40 (i.e. the parent's bank): receiving the transaction order, processing it, performing a balance transformation on the parent's account and informing a payee selected entity 2′ of the result of the balance transformation in the form of a transaction report over a fast communication channel.

In light of the above examples it will be apparent to a skilled person that the method according to the invention may be implemented with various modifications, however keeping the main advantages thereof:
the payee 2 is informed quasi real-time of the result of a balance transformation on the payor's account made in connection with a transaction order given by the payor 2, thereby the payee is informed quasi real-time of whether the transaction order can and is intended to be carried out;
the payee 2 can speed up its cash flow, since once being in possession of the bank promissory note he has the opportunity of selling the debt (or receiving advance payment—credit—from the payee selected financial service provider), which may be desirable for him if on the basis of the traditional banking procedures the actual financial clearing and settlement would take a longer period of time;
the financial settlement is preceded by a quasi real-time payment promissory note: the result of the balance transformation serves as a promissory note for the payment allowing the payee 2 to undertake any action in advance which would otherwise be conditional on the actual financial settlement;
the payor 1 does not need to share any personal or confidential data when ordering on-line as the transaction order is issued by him and not the payee 2 (i.e. the merchant offering goods or services on-line);
the comfort of the participants to the transaction (i.e. payor 1 and payee 2) is increased by the fact that they need only be in contact with their own known and trusted partners (i.e. the payor-selected financial service provider 40 and the payee-selected financial service provider 50 respectively) during the financial settlement of the transaction;
the transaction is simplified by the fact that there is no need for the inclusion of an intermediate party with whom, otherwise, the participants in the transaction would not be in contact at all;
the method according to the invention can be applied for the fast (quasi real-time) and reliable preparation and execution of business transactions and in particular of cash-free financial transactions in electronic commerce.

The foregoing discussion and the drawings are intended to be illustrative, and are not to be taken as limiting. Still other variations and modifications of the method steps are possible and will readily present themselves to those skilled in the art.

1. A method for the quasi real-time preparation and consecutive execution of a financial transaction between a payor and a payee, the method comprising the steps of:
receiving a transaction order by a payor selected financial service provider from the payor;
identifying the payor's account based on the transaction order;
performing a comparison check of the transaction order and the payor's account, wherein when the comparison check is successful executing a balance transformation on the payor's account in accordance with the transaction order;
establishing a communication channel with a payee-selected entity;
notifying the payee-selected entity of the result of the balance transformation over the communication channel, and
completing the financial settlement of the financial transaction.

2. The method according to claim 1, comprising:
establishing a communication channel with the payor; and
receiving the transaction order over the communication channel.

3. The method according to claim 1, wherein the payee-selected entity is selected from a group consisting of the payee, payee's designee and payee-selected financial service provider.

4. The method according to claim 1, wherein the payor selected financial service provider and the payee's designee are the same entity.

5. The method according to claim 1, wherein the payee-selected entity is a payee-selected financial service provider, the method further comprising:
the payee-selected financial service provider notifying a secondary payee-selected entity of the result of the balance transformation in advance of the completion of the financial settlement of the financial transaction.

6. The method according to claim 4, wherein the secondary payee-selected entity is selected from a group consisting of the payee and payee's designee.

7. The method according to claim 1, comprising:
the payee creating unique transaction identifying data for the financial transaction;
the payee providing the payor with the unique transaction identifying data; and
the payor creating the transaction order based on the unique transaction identifying data.

8. The method according to claim 7, comprising:
establishing a communication channel between the payee and the payor;
the payee providing the payor with the unique transaction identifying data over the communication channel.

9. The method according to claim 1, comprising:
communicating over the communication channel transaction information contained in the transaction order to the payee-selected entity; and
completing the financial settlement of the financial transaction only after receipt of a confirmation of the transaction information from the payee-selected entity.

10. The method according to claim 1, comprising completing the financial settlement of the financial transaction only after receipt of a performance confirmation from the payor.

11. The method according to claim 1, comprising initiating the financial settlement of the financial transaction substantially at the same time as the result of the balance transformation is sent to the payee-selected entity.

12. The method according to claim 1, comprising receiving a transaction order comprising a plurality of sub-transaction orders.

13. A method for the quasi real-time preparation and consecutive execution of a financial transaction between a payor and a payee which comprises the steps of:
the payee creating unique transaction identifying data for the financial transaction;
the payee providing the payor with the unique transaction identifying data; and
the payor creating the transaction order based on the unique transaction identifying data;
the payor forwarding the transaction order to a payor-selected financial service provider;
the payor-selected financial service provider performing a comparison check of the transaction order and the payor's account, wherein when the comparison check is successful executing a balance transformation on the payor's account in accordance with the transaction order;
the payor-selected financial service provider notifying a payee-selected financial service provider of the result of the balance transformation electronically;
the payor-selected financial service provider and the payee-selected financial service provider completing the financial settlement of the financial transaction.

14. The method according to claim 13, comprising the payee-selected financial service provider notifying a secondary payee selected entity of the result of the balance transformation, prior to the financial settlement of the transaction.

15. The method according to claim 14, wherein the secondary payee-selected entity is selected from a group consisting of the payee and payee's designee.
